(19) United States
(12) Patent Application Publication
(10) Pub. No.: US 2015/0176342 A1
(43) Pub. Date: Jun. 25, 2015

(54) MUD MOTOR DRIVE-SHAFT WITH IMPROVED BEARINGS

(71) Applicant: NEWSCO DIRECTIONAL SUPPORT SERVICES INC., Calgary (CA)

(72) Inventor: JOE FICKEN, Casper, WY (US)

(21) Appl. No.: 14/504,624

(22) Filed: Oct. 2, 2014

Related U.S. Application Data
(60) Provisional application No. 61/885,819, filed on Oct. 2, 2013.

(51) Int. Cl. E21B 17/05; F16D 3/224

(52) U.S. Cl. CPC E21B 17/05; F16D 3/224

(57) ABSTRACT

An improved arrangement for bearings for a drive-shaft for off-set or bent drive subassemblies between a mud-motor and a drill-bit in a bottom-hole assembly for directional drilling is provided by using elliptically shaped rollers housed in mating slots in the end or ends of the drive shaft to roll on their axes which are approximately perpendicular to the radius of the shaft and approximately aligned with the shaft's longitudinal axis, to engage with other mating slots in driven or driving housings attached to respectively the mud motor and to the drill's driven bit. The rollers are designed so that as the shaft pivots around a centroid of its tip end(s) the shape of the bearings' outer surface rotates within the slots with improved loading characteristics, with more bearing-to-slot surface area and less point loading than arrangements in the prior art, such as tapered roller bearings or ball bearings.

### FIELD OF THE INVENTION

Directional drilling subassemblies have some specific drive requirements which are problematic. Two examples are the movements inherent in progressive cavity mud motor rotors of the driving end of the rotor, which must be connected to the rotating bit which it is meant to drive, and the off-set or angle between elements of the bottom-hole assembly (such as the motor and the bit assembly) in an adjustable or bent-housing used in directional drilling. To accommodate these differences in angular alignment between rotating parts of the equipment, various types of universal joint and similar drive arrangements have been used. The invention addresses certain shortfalls in the prior art, and aims to provide a novel drive shaft for use between a progressive cavity or similar mud motor and the downhole portion of the drilling equipment, namely a rotating bit or similar driven equipment. As will be familiar to those skilled in the art, in addition to accommodating the variable angular differences in the driving and driven equipment, these drive-shafts must also be capable of sustaining large longitudinal loads (along their length) whether in vertical or deviated postures within the wellbore, and whether in compression or in tension.

### BACKGROUND OF THE INVENTION

In directional drilling settings, as opposed to vertical drilling, in particular in oil and gas exploration and production wells, given the depths and formations through which wells are bored, it is impractical to drive rotating drill bits from surface by rotating the entire drill string by forces applied at surface in order to rotate the bit attached in a rigid way to the string's bottom end. It is therefore typical now to place a motor at or near the bottom of the drill-string which can be driven by forces applied at surface which do not involve rotating the entire drill-string most commonly by pumping drilling fluid (mud) under pressure with sufficient flow rates and force to cause the motor to rotate. The motor is attached at its bottom end to a rotating drill. The motor will typically be a progressive cavity motor, with a fixed outer body or stator and a moving, rotating rotor. To develop the torque forces required to drive the drill bit, as the wellbore's size (diameter) decreases, the motor's length increases. Perversely, the length of the motor in a small diameter bore will decrease the ability of the motor and bit assembly to deviate much from linear drilling operations, and so it is desirable to be able to bend the assembly along its length to accommodate a tighter turning radius in a directional or deviated drilling operation. In addition, the mud motor will operate with better efficiency and less wear if the rotor is permitted to turn and at the same time deviate from rotating around a strictly centred axis within its stator's body. Generally, torque transfer capacity depends in most machines on so the radius of the rotating member; again perversely, when the radius of the wellbore is reduced, the outside diameter of downhole equipment must also be reduced and the torque transfer within the universal joint(s) on a drive shaft between an eccentrically rotating rotor of a mud motor, and the driven downhole equipment (such as a rotating bit) become extreme with small diameter rotating travel. Universal joints experience extreme loading, and wear quickly.

These conditions (the rotor's rotation not being centred, and the desire to bend the bottom hole assembly between the motor and the bit) can be accommodated with an intermediate drive-shaft between the motor's rotor and the bit assembly with what amounts to universal joints or constant-velocity joints at either end of the drive-shaft. Problematically, the shaft and the rotating bendable joints must also be capable of bearing longitudinal forces of compression and tension downhole, as well as high torque forces.

### EXAMPLES OF PRIOR ART

Several examples of prior art drive-shafts and bearing assemblies exist. Two which are of relevance are described below.

U.S. Pat. No. 4,904,228 to Frear (US '228) shows an improved universal ball joint adapted for use in high-torque situations such as downhole drilling. It includes a shaft with a ball end on one shaft received in a mating housing on another shaft (one being driven, the other driving). Opposed surfaces of the ball and the mating receptacle include axially extending grooves of essentially the same depth and length forming a plurality of chambers around the ball's circumference, each chamber to receive a pin which is tapered at both ends and forms the driving connection between the shafts.

U.S. Pat. No. 8,033,917 to Prill (US '917) provides a similar universal ball joint, but instead of the groove-pin-groove driving connection between similar ball-receiver assembly between two shafts, '917 provides for two or four pivoting drive keys mounted in the ball-end shaped to facilitate rotation of one shaft's axis with respect to the other shaft's axis (length-wise) while stopping rotation of one shaft's rotation about its axis with respect to the rotation of the other shaft about its own axis (thus providing a drive link between the two shafts).

### SUMMARY OF THE INVENTION

The improved drive shaft and bearing assembly of this invention provides a shaft with a parabolic shaped or rounded ball end received in a mating housing or retaining bonnet attached to another component of a drill-string's downhole assembly for transmitting rotational force (torque) from a motor to a drilling assembly at the bottom of the drill-string. The mating housing may have a drive seat with a parabolic pocket which mates with the outer surface of the end of the shaft's parabolic ball end, against which the shaft pivots during articulation of the joint between the shaft (and attached equipment) and the mating housing (and attached equipment). The opposing surfaces of the shaft's ball end and the receiver housing are provided with shaped mating voids forming chambers deployed about the ball end's circumference and within the receiver housing's inner mating circumference to receive elliptically shaped rollers. The rollers outer contact surface (except the rollers' ends) has a radius which maximizes the surface area of the roller which engages with the surface area of the mating voids on the driven and driving components (ball end and receiver housing), when the shaft is deviated from the components attached to the housing. Similar bearing arrangements are typically deployed at both ends of a drive shaft which is between a motor's drive (rotor) and a drill assembly downhole, and which can accommodate deviations encountered in bent shaft arrangements used in deviated drilling operations.

### BRIEF DESCRIPTION OF THE DRAWINGS

FIG. 1 shows an exploded view of the components in a typical downhole assembly which includes a mud motor and the drive shaft and bearings of this invention.

FIG. 2A shows a side elevation of a drive shaft of the invention,

FIG. 2B shows a cross-section of the ball-end at line C-C of FIG. 2C of a shaft of the invention with pockets or voids to receive the rollers.

FIG. 2C shows a cross-section of the shaft of the invention, cut along its longitudinal axis through its axis at line A-A of FIG. 2A.

FIG. 2D shows a plan view of a shaft of the invention.

FIG. 2E shows a view of one pocket or void formed in the ball-end radially above the side of a ball-end of a shaft of the invention at detail B of FIG. 2A.

FIG. 2F shows a cutaway cross section of detail D of FIG. 2C, to show an example of the dimensions of a void in the ball-end of a shaft,

FIG. 2G shows a cutaway section at detail E of FIG. 2B to show an example of the cross-section of the void in the ball-end of a shaft of the invention.

FIG. 3 shows a perspective view of the ball-end of a shaft of the invention.

FIG. 4 shows a perspective view of both the ball-end and receiving housing of the bearing assembly, with bearings in the ball-end pockets or voids, during assembly; also showing the housing's refittable collar.

FIG. 5 shows plan and perspective drawings of a roller of the invention.

FIG. 6 shows a perspective view of an assembled shaft with the receiving housing made semi-transparent to show engagement of the rollers in a shaft with a receiving housing.

FIG. 7A shows a cross-section of a motor assembly with a two-ended shaft with bearings of this invention in a mud-lube (unsealed or wash bearing) example

FIG. 7B shows a similar cross-section of a motor assembly with a two-ended shaft with bearings of this invention in another (sealed bearings) example

### DETAILED DESCRIPTION

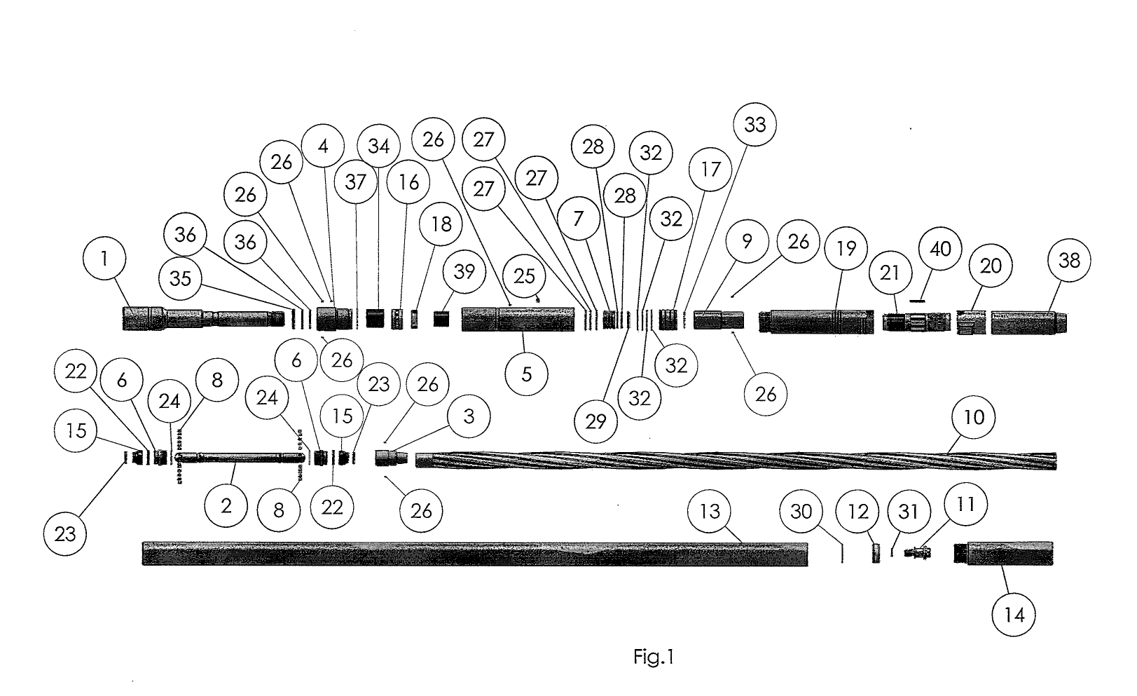

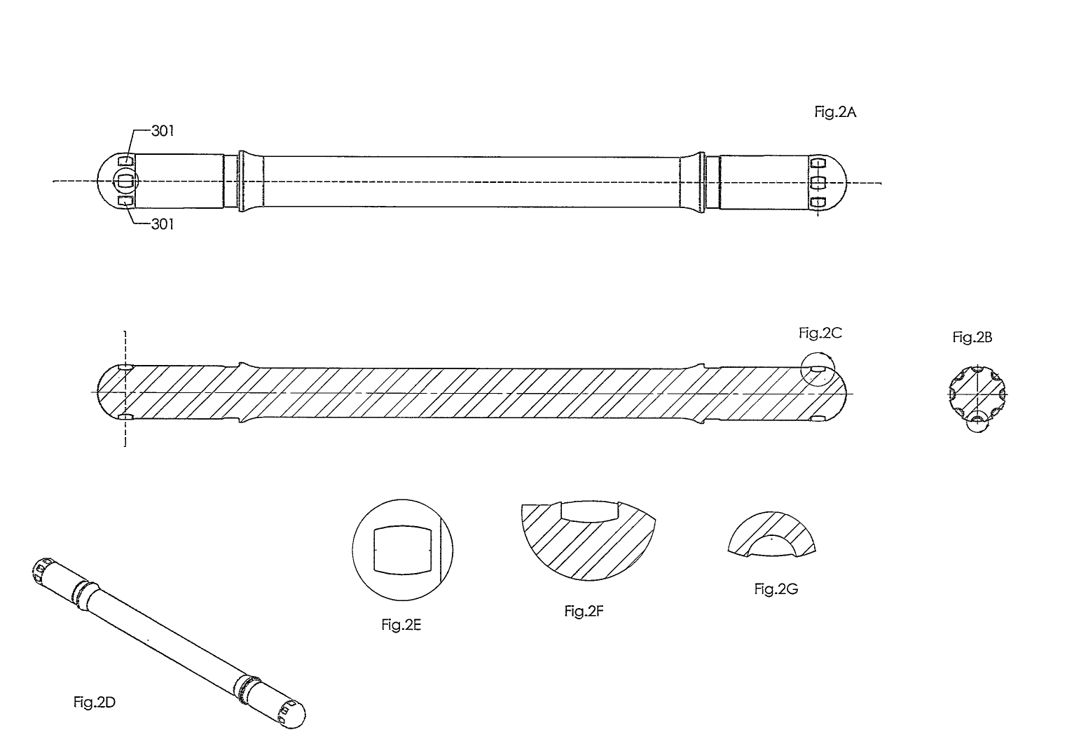

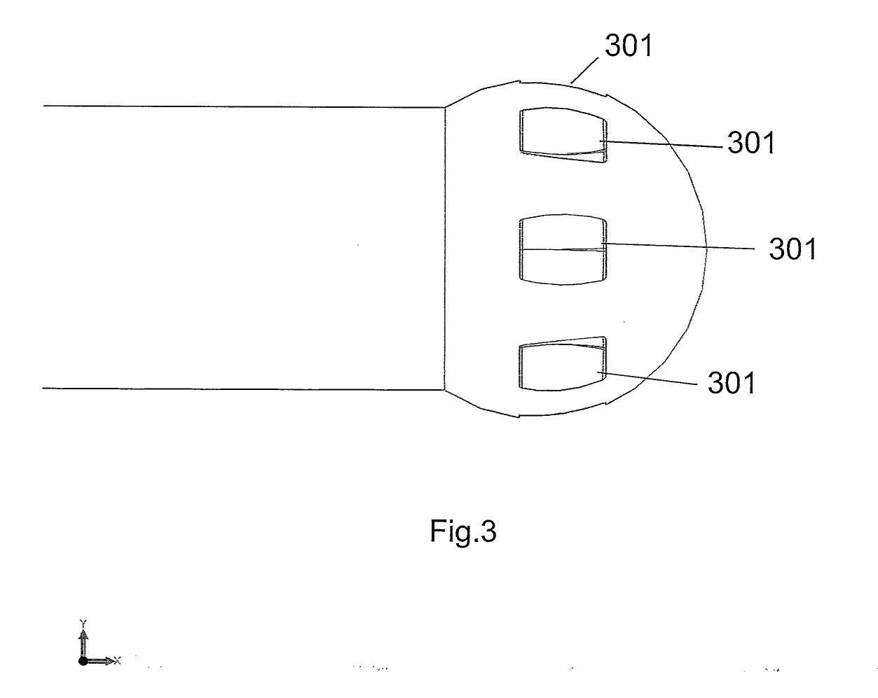

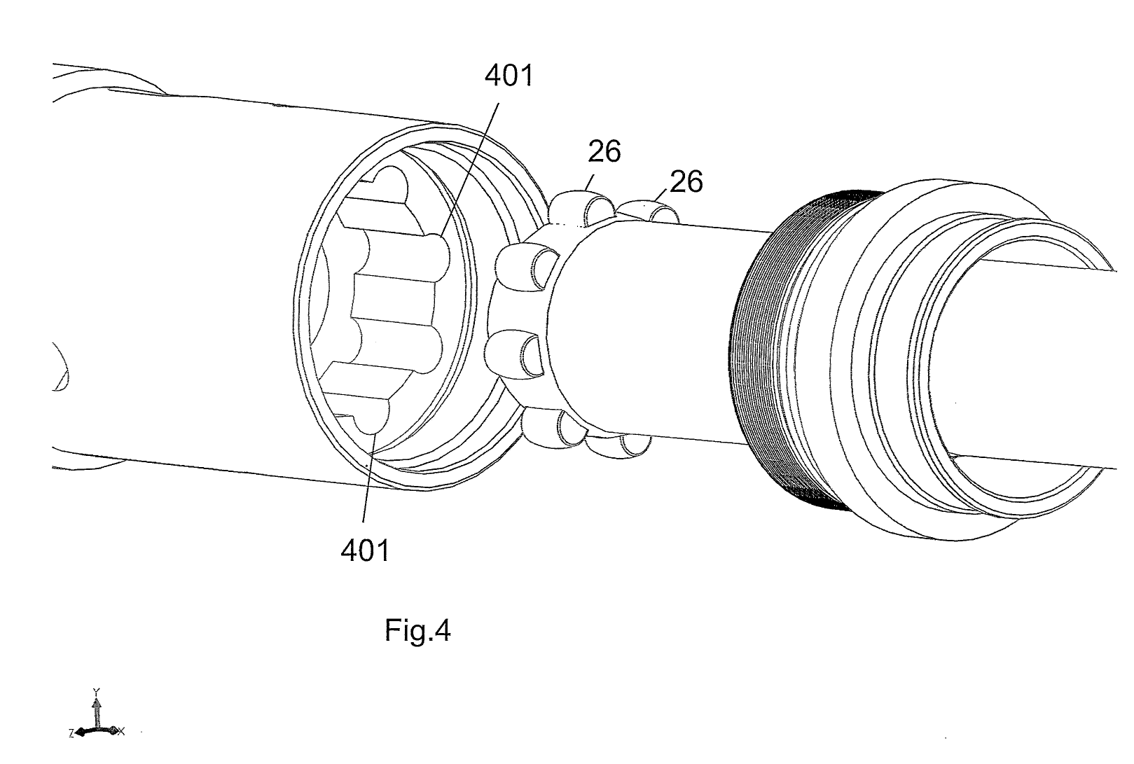

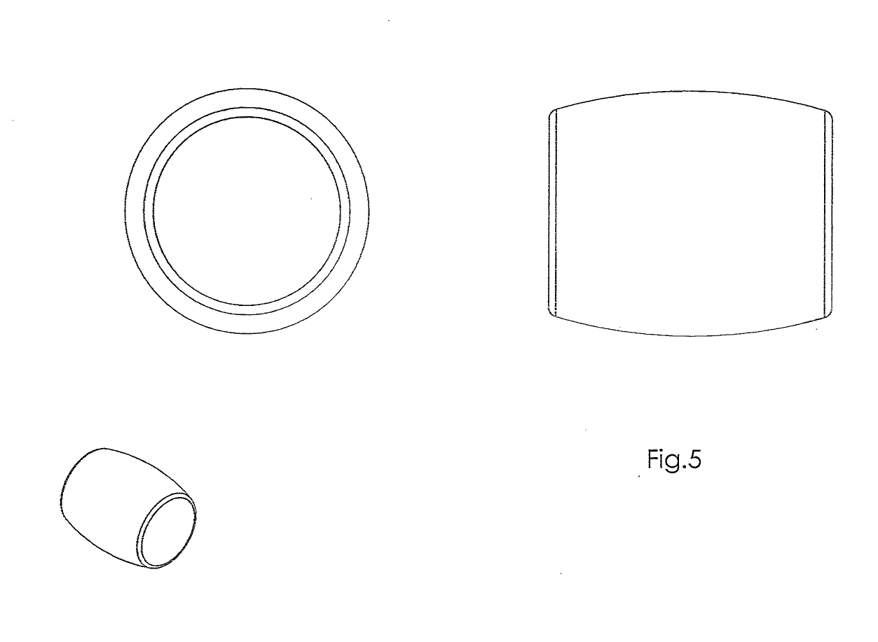

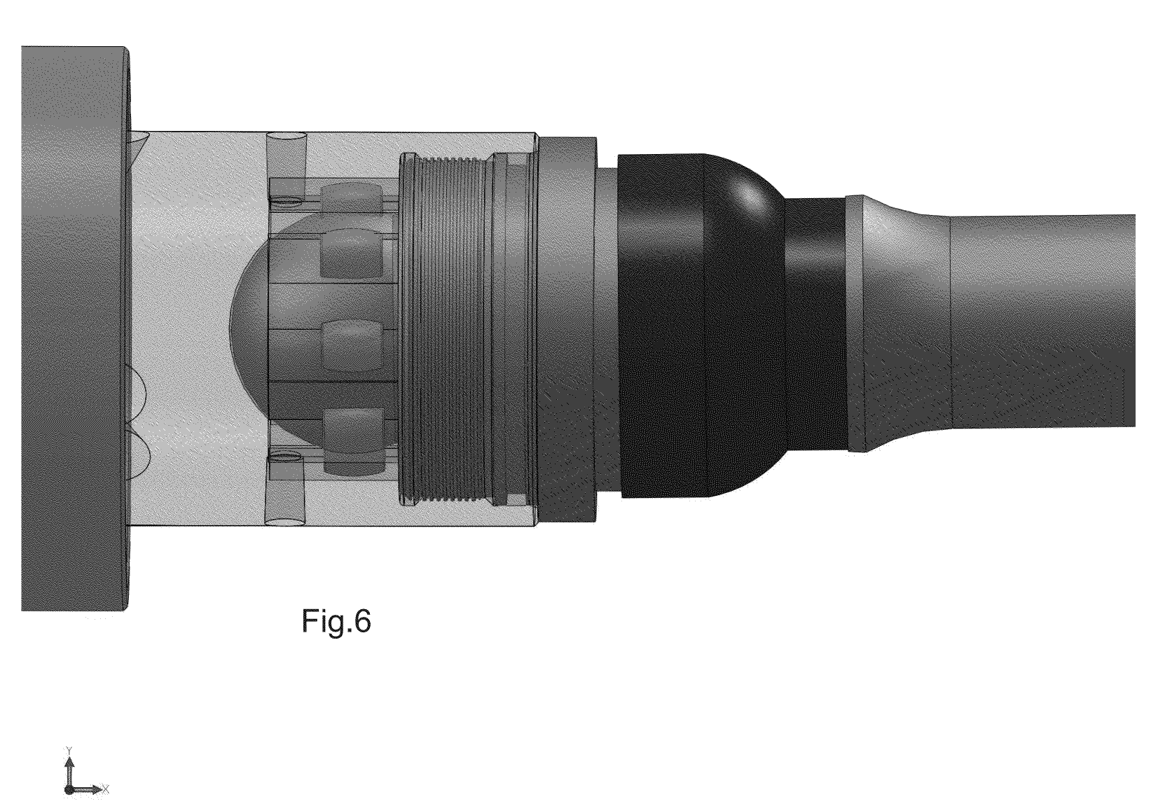

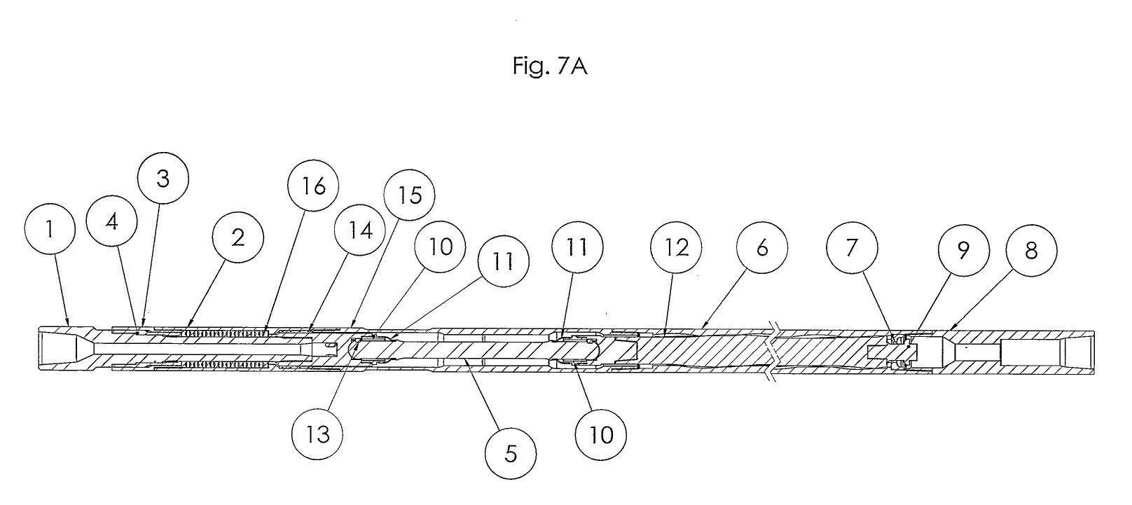

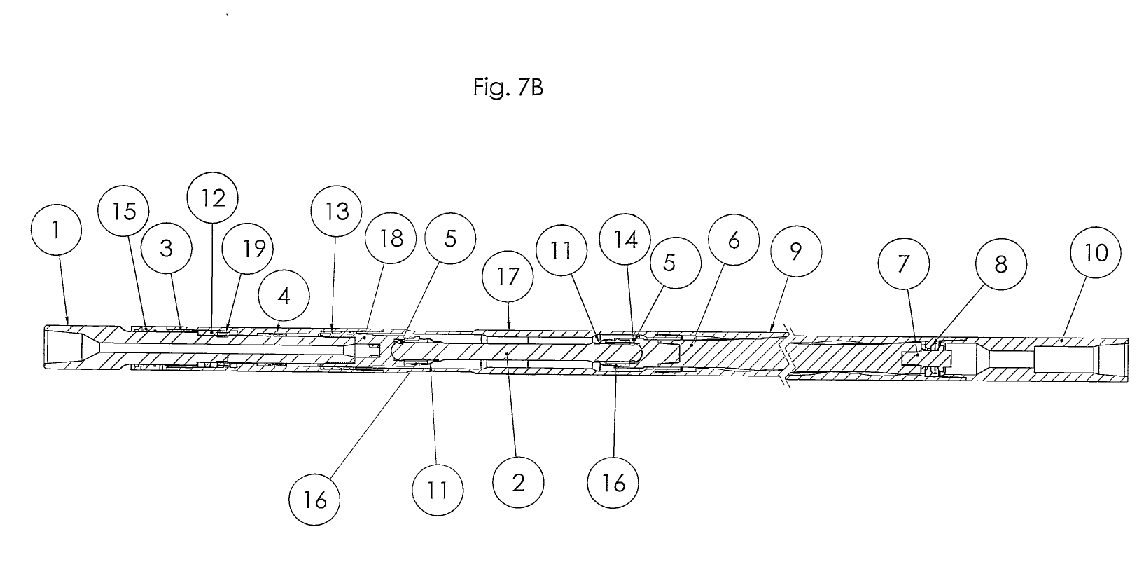

A drive-shaft assembly with two universal joint style thrust bearing assemblies for attachment between a progressive cavity type mud motor's rotor and driven downhole componentry in a bottom-hole assembly for deviated drilling is shown in FIG. 1. The drive shaft comprises a rotor adapter 28 attached to the motor's rotor 29, to which is attached a bonnet 22 into which is inserted upper ball-end of a drive shaft 27 into which rollers 26 have been inserted within the ball-end's sockets 301 for receiving the rollers 26 and which rollers 26 are also fitted in the receiving housing bonnet 22 receptacles 401, and when the bonnet 22 is fixed, in this case threadably, to the rotor adapter 28, a universal joint is formed between the shaft 27 and the rotor by attachment of the rotor adapter 28.

At the other, lower ball-end of the shaft 27, rollers 26 are similarly fitted to ball-end receptacles 301, which are fitted to a bonnet 22 with roller receptacles 401, and the bonnet 22 on the lower-end of the shaft 27 is attached to driven equipment lower in the drillstring (for instance, a bearing drive shaft 19 within a bent housing 20 for directing the direction of a drill-bit at the bottom of the string).

There may or may not be a seat in the bearing adapter or bonnet 22 at either or both ends. The putative circumference of the outer surface of each barrel-shaped roller 26 is designed to minimize point-loading between the roller and the roller receptacles 301, 401 when mated and under torque forces when the angle between the longitudinal axis of the shaft 27 and the equipment on either side of the shaft to which each bonnet 22 is attached changes. Angles of up to or greater than 3 degrees can be accommodated without serious point loading at the rollers' outer surface.

The roller 26 may be made of flexor metal, for example 4330 vanadium steel, and should be heat treated or otherwise treated to have a hardness of around 650 Rockwell. Pockets in the shaft 301 and housing receptacles 401 may be electrically hardened to similar Rockwell numbers on their mating surfaces.

These bearings and shaft assemblies are preferably used in 5″ or 6½″ drill strings. They may be sealed and bathed in lubricant, or may be mud lubricated and unsealed, operating bathed in drilling fluid.

It will be apparent to those skilled in the art that the embodiment described above is illustrative of the principle elements and operation of the invention as claimed, and that the claims are not limited by the example of the description, but by the terms of the claims themselves.

1. a bearing assembly for use in the transmission of torque in a bottom-hole assembly of a drilling system to provide a bendable drill-string while continuing to transfer torque past the bend, comprising:
a. a drive attachment to either a driven or drive component of a drive system of a bottom-hole assembly,
b. a bonnet attached at an outer end to the drive attachment and with an opening at the other end for a drive-shaft to protrude,
c. the drive shaft having a ball-end,
d. the bonnet when attached to the drive attachment will rotate simultaneously with the drive attachment's rotation, the bonnet being either driving or driven,
e. the bonnet having an internal receptacle to receive the ball-end of the drive shaft and to hold the drive shaft from excessive movement toward or away from the drive attachment,
f. the drive shaft having shaft receptacles on its outer surface for receiving a first part of mating rollers,
g. the bonnet's interior surface having bonnet receptacles for receiving a second part of the mating rollers,
h. the shaft receptacles and the bonnet receptacles being aligned when assembled to together form voids within which the mating rollers closely fit,
i. the mating rollers being barrel shaped each having a curved outer surface and being approximately cylindrical with a longitudinal roller axis,
j. the receptacles being aligned so that the longitudinal axes of each roller is approximately parallel to and radially spaced from the longitudinal axis of the drive shaft and the drive component when those components are aligned, and with each other,
k. the fit between the bonnet and the ball-end permitting the drive shaft's axis to deviate from or bend away from alignment with the axis of the drive component to which the bonnet is attached,
l. the mating surfaces of the receptacles of the bonnet and the shaft together with the rollers prevent the shaft from rotation without simultaneous rotation of the bonnet and the attached drive component.

2. The invention of claim 1 where at least one roller is 4330 Vandium steel alloy.

3. The invention of claim 1 where at least one receptacle is surface hardened.

4. The invention of claim 1 where the bonnet includes a seat for receiving the shaft's outer-most end at its ball-end in compression.

5. The invention of claim 1 where the bonnet's outer surface is attached to a boot or seal element which covers at least a part of the shaft and is in sealed but rotating engagement with the shaft, to seal the internal workings of the rollers and receptacles, ball-end and bonnet interior, from exposure to drilling fluid,

6. The invention of claim 1 where the drive shaft has a ball-end, rollers and a bonnet at both ends, and is used in a bottom hole assembly with an adjustable or bent housing for directional drilling powered by a progressive cavity mud motor's rotating rotor.
